(19) United States
(12) Patent Application Publication
(10) Pub. No.: US 2019/0265981 A1
(43) Pub. Date: Aug. 29, 2019

(54) FUNCTION ENHANCEMENT APPARATUS, CONTROL METHOD, AND PROGRAM PRODUCT

(71) Applicant: Fujitsu Client Computing Limited, Kanagawa (JP)

(72) Inventors: Hirotaka Yakame, Kawasaki (JP); Tatsuya Shimura, Kawasaki (JP); Tomonori Fujii, Kawasaki (JP); Taketoshi Hayashi, Osaka (JP)

(73) Assignee: Fujitsu Client Computing Limited, Kanagawa (JP)

(21) Appl. No.: 16/407,248

(22) Filed: May 9, 2019

Related U.S. Application Data
(63) Continuation of application No. PCT/JP2017/036200, filed on Oct. 4, 2017.

(30) Foreign Application Priority Data
Nov. 25, 2016 (JP) 2016-229545

(51) Int. Cl. G06F 9/4401; G06F 1/28

(52) U.S. Cl. CPC G06F 9/4416; G06F 1/28

(57) ABSTRACT

A function enhancement apparatus according to an embodiment includes: a connector to which an information processing device is connected; and a first processor that acquires a power source state of the information processing device connected to the connector, and causes, based on the acquired power source state, the information processing device to perform activation by power source control when an activation command to the information processing device is received from an external network.

### CROSS-REFERENCE TO RELATED APPLICATIONS

This application is national stage application of International Application No. PCT/JP2017/036200, filed Oct. 4, 2017, which designates the United States, incorporated herein by reference, and which claims the benefit of priority from Japanese Patent Application No. 2016-229545, filed Nov. 25, 2016, the entire contents of which are incorporated herein by reference.

### FIELD

The present disclosure relates to a function enhancement apparatus, an information processing system, and a control program for the function enhancement apparatus.

### BACKGROUND

When external I/O interfaces are added to information processing devices, the information processing devices are generally connected to function enhancement apparatuses that are referred to as cradles and docking stations including external I/O interfaces.

The information processing device is connected to the function enhancement apparatus by using a connection connector.

In recent years, with respect to the connection connector, a standard of USB Type-C/USB Power Delivery (hereinafter, referred to as “Type-C/UPD”) is established.

In a system compliant with the Type-C/UPD, an application specific integrated circuit (ASIC) referred to as a power delivery controller (hereinafter, referred to as “PD controller”) is mounted. The PD controller takes control related to detection of connection, power supply, and power source demand. In addition, a microcomputer referred to as an embedded controller (EC) that takes control of the PD controller and control of a power source is mounted. The EC mounted on the function enhancement apparatus and the EC mounted on the information processing device transmit/receive signals with vender defined message (VDM) communication performed through the respective PD controllers.

By contrast, the information processing device has a function of remote activation where a LAN connector receives an activation command via an external network and activates a system.

When remote activation is implemented by the function enhancement apparatus on which the Type-C connector is mounted, the LAN controller that converts a signal of a LAN into a signal of a USB is generally mounted on the function enhancement apparatus. When an activation command via a LAN connector is received, such the LAN controller can use both a USB signal and a general purpose input output (GPIO) signal for activation in order to activate a system. When a USB signal is used for activation, the LAN controller transmits an activation request to a CPU via a USB bus and causes the CPU to activate the information processing device. By contrast, when a GPIO signal for activation generated by the LAN controller is used for activation, the GPIO signal is transmitted to the EC in the information processing device using VDM communication. When the GPIO signal for activation is received, the EC mounted on the information processing device outputs a signal for turning on a power source of the information processing device and activates the information processing device.

Activation using a USB signal is available when a system is in sleep. Activation using a GPIO signal for activation is available at times in addition to the time when the system is in sleep, so long as a constant power supply of the EC and the PD controller is secured.

As a technique of such the remote activation, there is the conventional technique of activating an information processing device that is connected to a LAN via a serial bus.

### SUMMARY

One aspect of a function enhancement apparatus according to the present disclosure includes: a connector to which an information processing device is connected; and a first processor to acquire a power source state of the information processing device connected to the connector, and cause, based on the acquired power source state, the information processing device to perform activation by power source control when an activation command to the information processing device is received from an external network.

### BRIEF DESCRIPTION OF THE DRAWINGS

FIG. 1 is a view illustrating the configuration of an electronic system in accordance with embodiments.

FIG. 2 is a block diagram illustrating a terminal device and a docking station in accordance with a first embodiment.

FIG. 3 is a view illustrating an example of various kinds of signals used in the first embodiment.

FIG. 4 is a view illustrating a part of the format of a vender defined message (VDM) signal.

FIG. 5 is a flowchart of processing in an information processing system according to the first embodiment at the time of remote activation.

FIG. 6 is a block diagram illustrating the terminal device and the docking station in accordance with a second embodiment.

FIG. 7 is a view illustrating an example of various kinds of signals used in the second embodiment.

FIG. 8 is a flowchart of processing of the information processing system according to the second embodiment at the time of remote activation.

### DETAILED DESCRIPTION

According to the present disclosure, it is capable of performing remote activation using a Type-C connector. Exemplary embodiments of a function enhancement apparatus, an information processing system, and a control program of the function enhancement apparatus disclosed in the present application will be described in detail with reference to drawings. It should be noted that the embodiments below are not intended to limit the function enhancement apparatus, the information processing system, and the control program of the function enhancement apparatus disclosed in the present application.

### First Embodiment

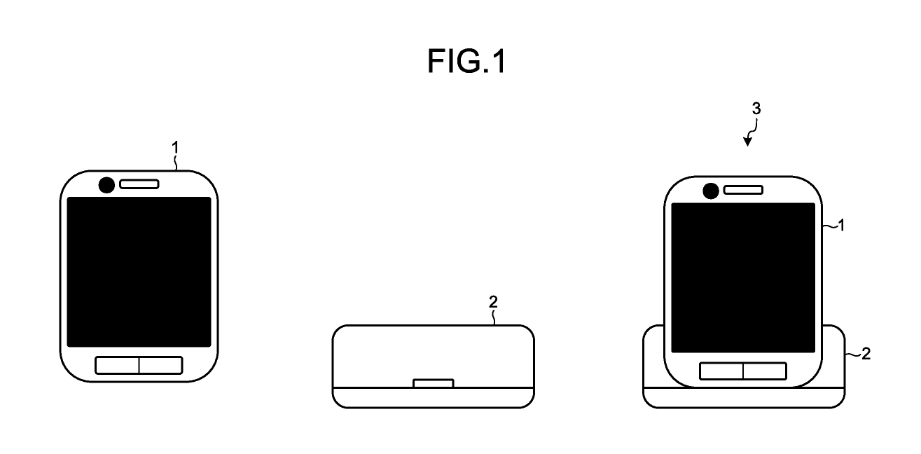

FIG. 1 is a view illustrating the configuration of an electronic system in accordance with the embodiments. As illustrated in FIG. 1, an information processing system 3 in accordance with the present embodiment includes a terminal device 1 and a docking station 2. The terminal device 1 is an example of the “information processing device”. The docking station 2 is an example of the “function enhancement apparatus”.

The terminal device 1 and the docking station 2 can be connected to each other. The information processing system 3 is structured by connecting the terminal device 1 and the docking station 2. In the case of the information processing system 3, the terminal device 1 can use functions of the docking station 2.

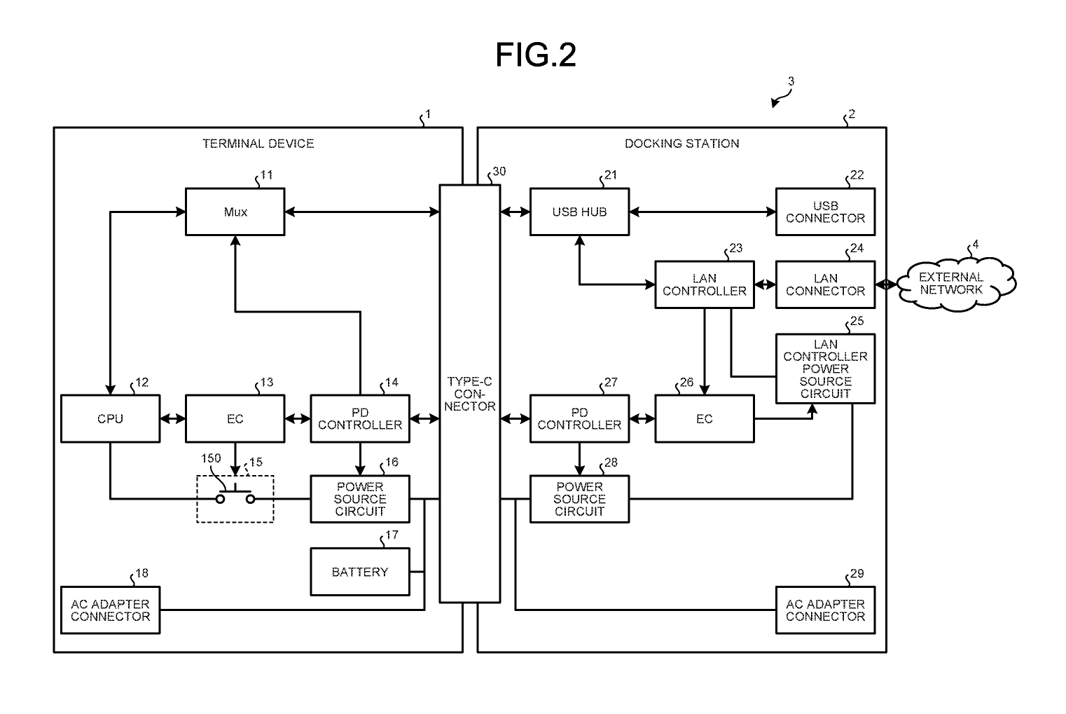

The information processing system 3 in accordance with the first embodiment will be described in detail with reference to FIG. 2. FIG. 2 is a block diagram illustrating the terminal device and the docking station in accordance with the first embodiment.

The terminal device 1 and the docking station 2 according to the first embodiment are connected to each other via a Type-C connector 30. Although FIG. 2 illustrates the Type-C connector 30 as one function unit, the Type-C connector 30 actually includes a connector of the terminal device 1 and a connector of the docking station 2. By fitting the connector of the terminal device 1 and the connector of the docking station 2 together, the terminal device 1 is connected to the docking station 2.

The Type-C connector 30 is compliant with the standard of Type-C/USB Power Delivery (UPD). The Type-C connector 30 relays communication with a USB signal and a GPIO signal. The Type-C connector 30 includes a configuration channel (CC) that is a dedicated signal line and a signal line that transmits a USB signal. The docking station 2 side of the Type-C connector 30 is one example of the “connection unit”.

As illustrated in FIG. 2, the terminal device 1 includes a multiplex (Mux) 11, a central processing unit (CPU) 12, an embedded controller (EC) 13, a power delivery (PD) controller 14, a power source switch circuit 15, a power source circuit 16, a battery 17, and an AC adapter connector 18. The terminal device 1 is one example of the “information processing device”.

The battery 17 is an auxiliary power source. The battery 17 outputs power stored by itself to the power source circuit 16.

An AC adapter is connected to the AC adapter connector 18. While the AC adapter is connected to the AC adapter connector 18, the AC adapter connector 18 receives supply of power from a commercial power source through the AC adapter. The AC adapter connector 18 outputs the supplied power to the power source circuit 16.

When the AC adapter is connected to the AC adapter connector 18 and the AC adapter serves as a power source, the power source circuit 16 receives power supply from the AC adapter. When the battery 17 serves as a power source, the power source circuit 16 receives supply of power from the battery 17. When power supply is received from the docking station 2, the power source circuit 16 receives supply of power from a power source circuit 28 through the Type-C connector 30.

Upon reception of an instruction from the PD controller 14, the power source circuit 16 supplies a power source type that the power source circuit 16 has created using power supplied from a power source to, for example, the CPU 12, the Mux 11, the EC 13, and the PD controller 14. FIG. 2 illustrates a route connected to the CPU 12 through the power source switch circuit 15 as one example of a power supply route, but actually, the power supply route extends from the power source circuit 16 to each of the units. Supply destinations of power from the power source circuit 16 illustrated in FIG. 2 are examples, and the power source circuit 16 supplies power to each of the units that uses electricity in the terminal device 1. When supplying power to the docking station 2, the power source circuit 16 supplies a created power source type to the power source circuit 28 through the Type-C connector 30. The power source circuit 16 constantly supplies power to the EC 13 and the PD controller 14 regardless of a power source state of the terminal device 1.

The following explains power source states of the terminal device 1. The power source states of the terminal device 1 include a shut-down state, a pause state, a sleep state, and an activation state.

The shut-down state includes the following two states. As one state, the terminal device 1 is in a state where power sources of almost all devices are cut except for a part of devices serving as a system restoration factor and devices using a constant power source such as the EC 13 and the PD controller 14. As the other state, the terminal device 1 is in a state where power sources of almost all devices are cut except for devices using a constant power source such as the EC 13 and the PD controller 14. The pause state is a state where a state of the terminal device 1 is stored in an auxiliary storage device (not illustrated) such as a hard disk and a power source is supplied to the auxiliary storage device and the like. In the shut-down state and in the pause state, a power source button 150 included in the power source switch circuit 15 is turned off and power is not supplied to the CPU 12.

The sleep state is a state where a state of the terminal device 1 is stored in a main storage device (not illustrated), such as a random access memory (RAM), and a power source is supplied to the main storage device and the CPU 12. The activation state is a state where all power sources used for operation of the terminal device 1 are turned on. In the sleep state and in the activation state, power is supplied to the CPU 12.

The power source switch circuit 15 includes the power source button 150 for connecting and disconnecting a power supply route to the CPU 12. When the terminal device 1 is in the sleep state and in the activation state, the power source button 150 is turned on and connects a power supply route to the CPU 12. When the terminal device 1 is in the shut-down state and in the pause state, the power source button 150 is turned off and disconnects a power supply route to the CPU 12. In addition, when remote activation is performed while the terminal device 1 is in the shut-down state and in the pause state, the power source switch circuit 15 receives input of a power source button ON signal from the EC 13 and switches the power source button 150 to on. Although the embodiment describes, specifically, power supply to the CPU 12, power is supplied to each of the units used for activation when remote activation is performed.

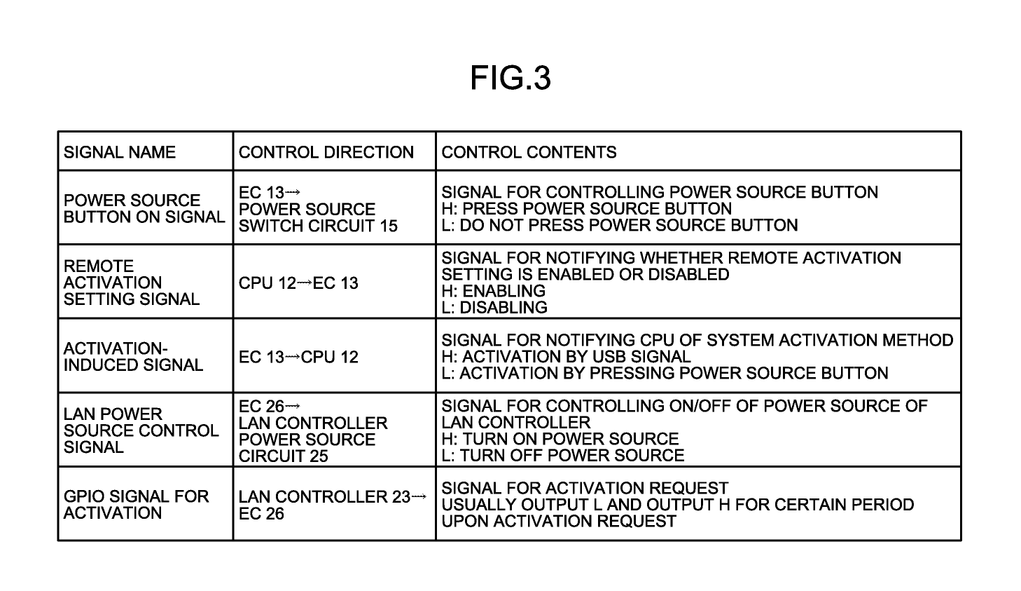

FIG. 3 is a view illustrating an example of various kinds of signals used in the first embodiment. As illustrated in FIG. 3, a power source button ON signal is a signal for controlling the power source button 150, which is transmitted from the EC 13 to the power source switch circuit 15. For example, a high level of the power source button ON signal represents that the power source switch circuit 15 is instructed to press the power source button 150. A low level of the power source button ON signal represents that the power source switch circuit 15 is instructed not to press the power source button 150. When the terminal device 1 is in the shut-down state and in the pause state, the power source switch circuit 15 receives input of a low-level power source button ON signal from the EC 13. After remote activation is performed, the power source switch circuit 15 receives input of a high-level power source button ON signal from the EC 13 and turns on the power source button 150.

The Mux 11 receives input of a connection state representing an insertion direction of the Type-C connector 30 from the PD controller 14. The Mux 11 determines a route for transmitting a USB signal from a USB hub 21 to the CPU 12 through the Type-C connector 30 and a route for transmitting a USB signal from the CPU 12 to the USB hub 21 through the Type-C connector 30.

A USB signal output by the USB hub 21 is transmitted to the CPU 12 by a route determined by the Mux 11 as a route for transmitting a USB signal from the USB hub 21 to the CPU 12 through the Type-C connector 30.

For example, a USB signal from the docking station 2 for activating the terminal device 1 is transmitted to the CPU 12 by a route selected by the Mux 11 as a route for transmitting a USB signal from the USB hub 21 to the CPU 12 through the Type-C connector 30. In the embodiment, the case where the docking station 2 transmits an activation instruction to the terminal device 1 by using a USB signal is, in other words, a case where the docking station 2 performs remote activation on the terminal device 1 by using a USB signal.

A USB signal output by the CPU 12 is output to the USB hub 21 through the Type-C connector 30 by using a route selected by the Mux 11 as a route for transmitting a USB signal from the CPU 12 to the USB hub 21 through the Type-C connector 30.

The CPU 12 is an arithmetic processing unit of the terminal device 1. When the power source button 150 in the power source switch circuit 15 is turned on, the CPU 12 receives power supply from the battery 17 or the AC adapter connector 18 through the power source circuit 16. When the power source button 150 in the power source switch circuit 15 is turned off, the CPU 12 does not receive supply of power. Power supplied from the battery 17 or the AC adapter connector 18 causes the CPU 12 to operate.

When the terminal device 1 is in the sleep state, the CPU 12 receives input of a USB signal for activation output from the USB hub 21 via a route selected by the Mux 11 for transmitting a USB signal from the USB hub 21 to the CPU 12 through the Type-C connector 30. In this case, a USB signal output from the USB hub 21 is transmitted to the CPU 12 via a signal line of the Type-C connector 30 for a USB signal. When a USB signal for activation is input, the CPU 12 starts activation, and activates the terminal device 1.

By contrast, when the terminal device 1 is in the shut-down state or the pause state, power is not supplied to the CPU 12. Thus, it is difficult for the CPU 12 to perform activation with USB signal. When the terminal device 1 is in the shut-down state or the pause state, the CPU 12 receives input of an activation-induced signal from the EC 13 after the power source button 150 is turned on by the EC 13, as will be described later. When an activation-induced signal is input, the CPU 12 starts activation and activates the terminal device 1.

When a power source state of the terminal device 1 is changed, the CPU 12 notifies the EC 13 of the power source state of the terminal device 1. The CPU 12 establishes communication with the EC 13 by using, for example, a GPIO signal. In addition, the CPU 12 receives input of information that indicates enabling/disabling of remote activation through a jumper switch and the like from an operator. The CPU 12 outputs a remote activation setting signal for notifying enabling/disabling of remote activation to the EC 13.

As illustrated in FIG. 3, a remote activation setting signal is transmitted from the CPU 12 to the EC 13, which is a signal for notifying of the remote activation setting of the terminal device 1 being enabled or disabled. For example, a high level of the remote activation setting signal represents that the remote activation setting of the terminal device 1 is enabled. A low level of the remote activation setting signal represents that the remote activation setting of the terminal device 1 is disabled. When the remote activation setting is enabled, the CPU 12 inputs a high-level remote activation setting signal to the EC 13. When the remote activation setting is disabled, the CPU 12 inputs a low-level remote activation setting signal to the EC 13.

At the time when the terminal device 1 and the docking station 2 are connected to each other, the EC 13 receives, from the PD controller 14, input of an interruption caused by detecting the connection. The EC 13 acquires information on the cause of the interruption and accompanying data from the PD controller 14 by serial communication and the like. Examples of the serial communication include an inter-integrated circuit (I2C). The EC 13 outputs a release notification of the interruption to the PD controller 14.

When a power source state of the terminal device 1 is changed, the EC 13 receives from the CPU 12 a notification of a power source state of the terminal device 1. The EC 13 stores the acquired power source state of the terminal device 1.

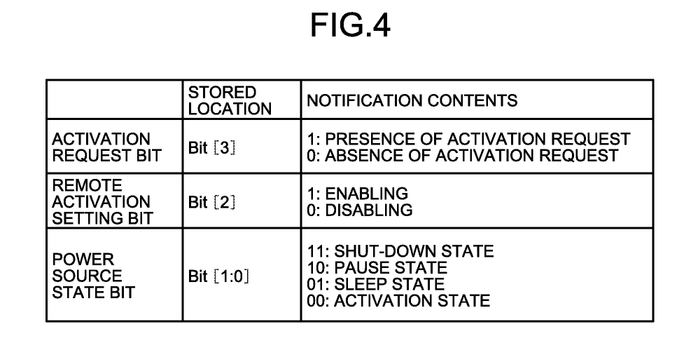

Furthermore, the EC 13 sets a value representing a power source state of the terminal device 1 to a power source state bit in a vender defined message (VDM) signal, and instructs the PD controller 14 to transmit the VDM signal. The following describes a VDM signal with reference to FIG. 4. FIG. 4 is a view illustrating a part of the format of a VDM signal. A VDM signal is a signal used for CC communication with a CC serving as a dedicated signal line through the Type-C connector 30. A VDM signal is defined by specifications of the UPD and includes two areas that are Structured VDM and Unstructured VDM. The Structured VDM stores a power supply direction, a transmission direction of a signal, signal types such as Success and Negative Acknowledgement (NACK), amounts of data, and the like. The Unstructured VDM is an undefined area, and has a 7-byte size. Each of bits illustrated in FIG. 4 represents a bit in the Unstructured VDM.

In the first embodiment, the zero and first bits in the Unstructured VDM are a power source state bit that represents a power source state of the terminal device 1. When a value of a power source state bit is 11, this value represents the shut-down state. When a value of a power source state bit is 10, this value represents the pause state. When a value of a power source state bit is 01, this value represents the sleep state. When a value of a power source state bit is 00, this value represents the activation state.

The EC 13 notifies the docking station 2 of the power source state of the terminal device 1 by setting a value representing a current power source state of the terminal device 1 to a power source state bit and instructing the PD controller 14 to transmit a VDM signal.

The EC 13 receives input of a remote activation setting signal from the CPU 12. The EC 13 sets a value representing information on enabling/disabling of remote activation specified by a remote activation setting signal to a remote activation setting bit in a VDM signal, and instructs the PD controller 14 to transmit the VDM signal.

In the first embodiment, as illustrated in FIG. 4, the second bit of the Unstructured VDM is a remote activation setting bit that represents enabling/disabling of remote activation. When a value of a remote activation setting bit is 1, this value represents that remote activation is enabled. When a value of a remote activation setting bit is 0, this value represents that remote activation is disabled.

In other words, the EC 13 sets a value representing information on enabling/disabling of remote activation specified by a remote activation setting signal to a remote activation setting bit and instructs the PD controller 14 to transmit a VDM signal so as to notify the docking station 2 of enabling/disabling of remote activation.

In addition, when the terminal device 1 is in the shut-down state or the pause state, the EC 13 receives an interruption induced by a VDM signal to which an activation request bit is set from the PD controller 14. The EC 13 determines presence or absence of an activation request from a value of an activation request bit in a VDM signal acquired by the PD controller 14.

In the first embodiment, as illustrated in FIG. 4, the third bit of the Unstructured VDM is an activation request bit that represents presence or absence of an activation request. When a value of an activation request bit is 1, this value represents that an activation request is present. When a value of an activation request bit is 0, this value represents that an activation request is absent. In other words, when a value of an activation request bit in a VDM signal acquired by the PD controller 14 is 1, the EC 13 determines that an activation request for the terminal device 1 is present.

When an activation request is present, the EC 13 outputs a power source button ON signal that instructs the power source button 150 to be turned on to the power source switch circuit 15. For example, when a signal illustrated in FIG. 3 is used, the EC 13 changes the level of a power source button ON signal that is output to the power source switch circuit 15 from a low level to a high level.

Subsequently, the EC 13 outputs an activation-induced signal for notifying a system activation method to the CPU 12, and causes the CPU 12 to start activation. As illustrated in FIG. 3, an activation-induced signal is a signal for notifying the CPU 12 of a system activation method that is transmitted from the EC 13 to the CPU 12, and is a general purpose input output (GPIO) signal. For example, in case of a high level, an activation-induced signal specifies activation with a USB signal. In case of a low level, an activation-induced signal specifies activation by pressing of the power source button 150. In other words, the EC 13 usually outputs a low-level activation-induced signal to the CPU 12, and changes, when an activation request by a VDM signal is detected, the level of the activation-induced signal that is output to the CPU 12 to a high level. In this manner, the EC 13 instructs the CPU 12 to start activation.

When the terminal device 1 is connected to the docking station 2, the PD controller 14 establishes communication with a PD controller 27 in the docking station 2 through the Type-C connector 30 by the CC communication.

When connection between the terminal device 1 and the docking station 2 is detected, the PD controller 14 outputs an interruption caused by connection detection to the EC 13. After the EC 13 acquires specification of an interruption cause and accompanying data from the PD controller 14 by serial communication and the like, the PD controller 14 receives notification of interruption release from the EC 13 and releases the interruption. After initialization of the PD controller 27 is completed, the PD controller 14 executes USB Type-C connection processing with the PD controller 27. For example, the PD controller 14 determines the power supply and demand of a power source performing a power supply direction and power supply, a port used for a supply voltage and communication, and the like, and the setting of communication with the PD controller 27. When USB Type-C connection processing is completed, the PD controller 14 notifies the EC 13 and the power source circuit 16 of the power supply and demand and the setting of communication. The PD controller 14 also acquires a connection state of the Type-C connector 30 in insertion direction. The PD controller 14 notifies the Mux 11 of a connection state of the Type-C connector 30 in insertion direction.

The PD controller 14 receives an instruction for transmitting a VDM signal to which a remote activation setting bit is set from the EC 13. The PD controller 14 transmits a VDM signal to which a remote activation setting bit is set to the PD controller 27 through the Type-C connector 30 by the CC communication.

In addition, the PD controller 14 receives an instruction for transmitting a VDM signal to which a power source state bit is set from the EC 13. The PD controller 14 transmits a VDM signal to which a power source state bit is set to the PD controller 27 through the Type-C connector 30 by the CC communication.

Furthermore, the PD controller 14 receives a VDM signal to which an activation request bit is set from the PD controller 27 through the Type-C connector 30 by the CC communication. The PD controller 14 outputs an interruption caused by reception of a VDM signal to which an activation request bit is set to the EC 13.

The docking station 2 includes the USB hub 21, a USB connector 22, a LAN controller 23, a LAN connector 24, a LAN controller power source circuit 25, an EC 26, the PD controller 27, the power source circuit 28, and an AC adapter connector 29.

Various kinds of USB devices, such as an external storage device, a keyboard and a mouse, are connected to the USB connector 22. The USB connector 22 outputs a signal input from a connected USB device to the USB hub 21. The USB connector 22 also outputs a signal input from the USB hub 21 to a connected USB device.

The USB hub 21 is connected to the USB connector 22 and the LAN controller 23. The USB hub 21 outputs a USB signal input from the USB connector 22 or the LAN controller 23 to the CPU 12 through the Type-C connector 30. The USB hub 21 receives a USB signal output from the CPU 12. The USB hub 21 outputs, following a destination of a received signal, the received signal to the USB connector 22 or the LAN controller 23. When the terminal device 1 is in the shut-down state or the pause state, power of the power source circuit 28 is not supplied to the USB hub 21. Thus, when the terminal device 1 is in the shut-down state or the pause state, the USB hub 21 stops operation, and does not transmit, even when the USB hub 21 receives input of a USB signal for activation from the LAN controller 23 in a state where the USB hub 21 stops operation, the USB signal for activation to the CPU 12.

For example, the USB hub 21 receives input of a USB signal for activation that instructs the terminal device 1 to be activated from the LAN controller 23. The USB hub 21 outputs an acquired USB signal for activation to the CPU 12 through the Type-C connector 30. In this case, a USB signal output from the USB hub 21 is transmitted to the CPU 12 via a signal line of the Type-C connector 30 for a USB signal.

The LAN connector 24 is a network interface for transmitting/receiving a signal with an external network 4. A network cable connected to the external network 4 is connected to the LAN connector 24. The LAN connector 24 outputs a LAN signal input from the external network 4 to the LAN controller 23. In addition, the LAN connector 24 transmits a LAN signal input from the LAN controller 23 to the external network 4.

The LAN controller 23 controls a LAN signal. The LAN controller 23 receives power supply from the LAN controller power source circuit 25 so as to operate. The LAN controller 23 carries a USB-LAN conversion chip that converts a LAN signal into a USB signal.

The LAN controller 23 receives input of a LAN signal from the LAN connector 24. The LAN controller 23 converts a LAN signal of the protocol of the Institute of Electrical and Electronics Engineers (IEEE) 802.3 into a USB signal of the USB protocol. The LAN controller 23 outputs a USB signal that the LAN controller 23 has generated by converting a LAN signal to the USB hub 21.

The LAN controller 23 also receives input of an activation command to the terminal device 1 (such as a magic packet) that is a LAN signal from the external network 4 through the LAN connector 24. The LAN controller 23 converts the received activation command into a USB signal so as to generate the USB signal for activation. The LAN controller 23 outputs a USB signal for activation to the USB hub 21. In addition, the LAN controller 23 outputs a GPIO signal for activation to the EC 26. The USB signal for activation corresponds to an example of a “first activation request”. The GPIO signal for activation corresponds to an example of a “second activation request”.

As illustrated in FIG. 3, a GPIO signal for activation is a signal for an activation request that is transmitted from the LAN controller 23 to the EC 26. For example, in case of a high level, a GPIO signal for activation makes an activation request. The LAN controller 23 usually outputs a low-level GPIO signal for activation to the EC 26, and transmits, when an activation command is received, a high-level GPIO signal for activation to the EC 26 for a certain period.

The LAN controller power source circuit 25 receives supply of power from the power source circuit 28. The LAN controller power source circuit 25 also receives input of a LAN power source control signal for specifying on/off of a power source to the LAN controller 23 from the EC 26. When a LAN power source control signal specifies on of a power source to the LAN controller 23, the LAN controller power source circuit 25 supplies power supplied from the power source circuit 28 to the LAN controller 23. By contrast, when a LAN power source control signal specifies off of a power source to the LAN controller 23, the LAN controller power source circuit 25 stops supplying power supplied from the power source circuit 28 to the LAN controller 23.

When the terminal device 1 and the docking station 2 are connected to each other, the EC 26 receives input of an interruption caused by connection detection from the PD controller 27. Subsequently, the EC 26 checks an interruption cause and data accompanying the cause with serial communication, and recognizes connection between the terminal device 1 and the docking station 2. After that, the EC 26 instructs the PD controller 27 to release an interruption. In addition, the EC 26 receives notification for the power supply and demand and the setting of communication from the PD controller 27.

The EC 26 receives an interruption induced by a VDM signal to which a remote activation setting bit is set from the PD controller 27. The EC 26 checks a remote activation setting bit of a VDM signal acquired by the PD controller 27, and determines enabling/disabling of the remote activation setting. When the remote activation setting is enabled, the EC 26 outputs, even when the terminal device 1 is in the shut-down state or the pause state, a LAN power source control signal for specifying on of a power source to the LAN controller 23 to the LAN controller power source circuit 25. By contrast, When the remote activation setting is disabled, the EC 26 outputs, when the terminal device 1 is in the shut-down state or the pause state, a LAN power source control signal for specifying off of a power source to the LAN controller 23 to the LAN controller power source circuit 25. In this manner, when the terminal device 1 is in the shut-down state or the pause state, the LAN controller 23 stops operation and remote activation of the terminal device 1 is not performed.

As illustrated in FIG. 3, a LAN power source control signal is a signal for controlling on/off of a power source of the LAN controller 23 that is transmitted from the EC 26 to the LAN controller power source circuit 25. For example, in case of a high level, a LAN power source control signal causes a power source of the LAN controller 23 to be turned on. In case of a low level, a LAN power source control signal causes a power source of the LAN controller 23 to be turned off. When the remote activation setting is enabled and the terminal device 1 is in the shut-down state or the pause state, the EC 26 outputs a high-level LAN power source control signal to the LAN controller power source circuit 25 and maintains a state where a power source of the LAN controller 23 is turned on. By contrast, when the remote activation setting is disabled, the EC 26 outputs, even when the terminal device 1 is in the shut-down state or the pause state, a low-level LAN power source control signal to the LAN controller power source circuit 25, and turns off a power source of the LAN controller 23.

The EC 26 also receives an interruption induced by a VDM signal to which a power source state bit is set from the PD controller 27. The EC 26 acquires a power source state of the terminal device 1 from a value of a power source state bit of a VDM signal acquired by the PD controller 27. The EC 26 stores a power source state of the terminal device 1.

In addition, when an activation command is input from the external network 4 and the remote activation setting is enabled, the EC 26 receives input of a GPIO signal for activation from the LAN controller 23. The EC 26 checks a stored power source state of the terminal device 1. When a power source state of the terminal device 1 is the sleep state or the activation state, the EC 26 does not transmit a VDM signal for making an activation request.

By contrast, when a power source state of the terminal device 1 is the shut-down state or the pause state, the EC 26 sets a value representing that an activation request is present to an activation request bit in a VDM signal, and instructs the PD controller 27 to transmit the VDM signal. The EC 26 corresponds to an example of a “control unit”. Transmitting an activation request to the terminal device 1 by using a VDM signal and causing the CPU 12 to perform activation by turning on the power source button 150 corresponds to “causing the information processing device to perform activation by power source control”.

The EC 26 preliminarily stores a computer program that implements functions of acquiring power source states described above and of transmitting a CC signal to the terminal device 1 and turning on the power source button 150 so as to activate the terminal device 1 in a storage unit, and reads and executes the computer program so as to implement each function.

When connection between the terminal device 1 and the docking station 2 is detected, the PD controller 27 outputs an interruption caused by connection detection to the EC 26. After the EC 26 acquires specification of an interruption cause and accompanying data from the PD controller 27 by serial communication and the like, the PD controller 27 receives notification of interruption release from the EC 26, and releases the interruption. After initialization is completed, the PD controller 27 executes USB Type-C connection processing with the PD controller 14. For example, the PD controller 27 determines the power supply and demand of a power source performing a power supply direction and power supply, a port used for a supply voltage and communication, and the like, and the setting of communication with the PD controller 14. When USB Type-C connection processing is completed, the PD controller 27 notifies the EC 26 and the power source circuit 28 of the power supply and demand, and the setting of communication.

The PD controller 27 receives a VDM signal to which a remote activation setting bit is set from the PD controller 14 through the Type-C connector 30 by the CC communication. The PD controller 27 outputs an interruption caused by a VDM signal to which a remote activation setting bit is set to the EC 26.

In addition, the PD controller 27 receives a VDM signal to which a power source state bit is set from the PD controller 14 through the Type-C connector 30 by the CC communication. The PD controller 27 outputs an interruption caused by a VDM signal to which a power source state bit is set to the EC 26.

Furthermore, the PD controller 27 receives an instruction for transmitting a VDM signal where a value representing enabling/disabling of remote activation is set to a remote activation setting bit is set from the EC 26. The PD controller 27 transmits a VDM signal where a value representing enabling/disabling of remote activation is set to a remote activation setting bit to the PD controller 14 through the Type-C connector 30 by the CC communication.

An AC adapter is connected to the AC adapter connector 29. While an AC adapter is connected to the AC adapter connector 29, the AC adapter connector 29 receives supply of power from a commercial power source from the AC adapter. The AC adapter connector 29 outputs the supplied power to the power source circuit 28.

When an AC adapter is connected to the AC adapter connector 29 and the AC adapter serves as a power source, the power source circuit 28 receives power supply from the AC adapter. When power supply is received from the docking station 2, the power source circuit 28 receives supply of power from the power source circuit 16 through the Type-C connector 30.

Upon reception of an instruction from the PD controller 27, the power source circuit 28 supplies a power source type that the power source circuit 28 has created by using power supplied from a power source to, for example, the USB hub 21, the LAN controller power source circuit 25, the EC 26, and the PD controller 27. FIG. 2 illustrates a route connected to the LAN controller power source circuit 25 as one example of a power supply route from the power source circuit 28, but actually the power supply route extends from the power source circuit 28 to each of the units. Supply destinations of power from the power source circuit 28 illustrated in FIG. 2 are examples, and the power source circuit 28 supplies power to each of the units that uses electricity in the docking station 2. When supplying power to the terminal device 1, the power source circuit 28 supplies a created power source type to the power source circuit 16 through the Type-C connector 30. The power source circuit 28 constantly supplies power to the EC 26, the PD controller 27, and the LAN controller power source circuit 25 regardless of a power source state of the terminal device 1.

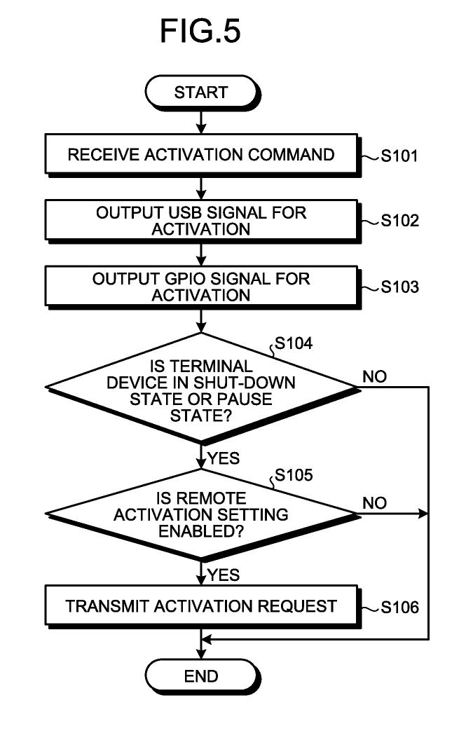

The following describes a flow of processing of the information processing system 3 according to the first embodiment at the time of remote activation with reference to FIG. 5. FIG. 5 is a flowchart of processing of the information processing system according to the first embodiment at the time of remote activation.

The LAN controller 23 receives an activation command from the external network 4 through the LAN connector 24 (step S101).

Subsequently, the LAN controller 23 converts an activation command from a LAN signal to a USB signal so as to generate the USB signal for activation. The LAN controller 23 outputs a USB signal for activation to the CPU 12 through the USB hub 21 and the Type-C connector 30 (step S102).

Furthermore, the LAN controller 23 outputs a GPIO signal for activation to the EC 26 (step S103).

The EC 26 receives input of a GPIO signal for activation. The EC 26 determines which of the shut-down state and the pause state a stored power source state of the terminal device 1 is (step S104). When the power source state of the terminal device 1 is the sleep state, in other words, when the power source state of the terminal device 1 is neither the shut-down state nor the pause state (No at step S104), the EC 26 ends processing for transmitting an activation request signal.

On the other hand, when a power source state of the terminal device 1 is either the shut-down state or the pause state (Yes at step S104), the EC 26 determines whether or not the remote activation setting is enabled (step S105). In the first embodiment, when the remote activation setting is disabled, power supply to the LAN controller 23 is stopped, and the EC 26 does not receive input of a GPIO signal. Thus, it is normally determined that the remote activation setting is enabled. However, in consideration of a case where power supply to the LAN controller 23 is failed to be stopped and the like, enabling/disabling of the remote activation setting is determined by the EC 26. When the remote activation setting is disabled (No at step S105), the EC 26 terminates processing of transmitting an activation request signal.

On the other hand, when the remote activation setting is enabled (Yes at step S105), the EC 26 instructs the PD controller 27 to transmit a VDM signal in which a value of an activation request bit is set as presence of an activation request. In this manner, the EC 26 transmits an activation request to the terminal device 1 by the CC communication (step S106).

As described above, when a power source state of the terminal device is the sleep state, the information processing system according to the first embodiment does not transmit a signal for turning on a power source button and activating the terminal device using The CC communication, but activates the terminal device with a USB signal. When a power source state of a terminal device is the shut-down state or the pause state, the information processing system according to the first embodiment turns on a power source button and activates the terminal device using The CC communication. In this manner, the information processing system according to the present embodiment can avoid conflict between a USB signal for activation and a signal for turning on a power source button and performing activation, and can compatibly perform activation using a USB signal and activation using a signal for turning on a power source button.

### Second Embodiment

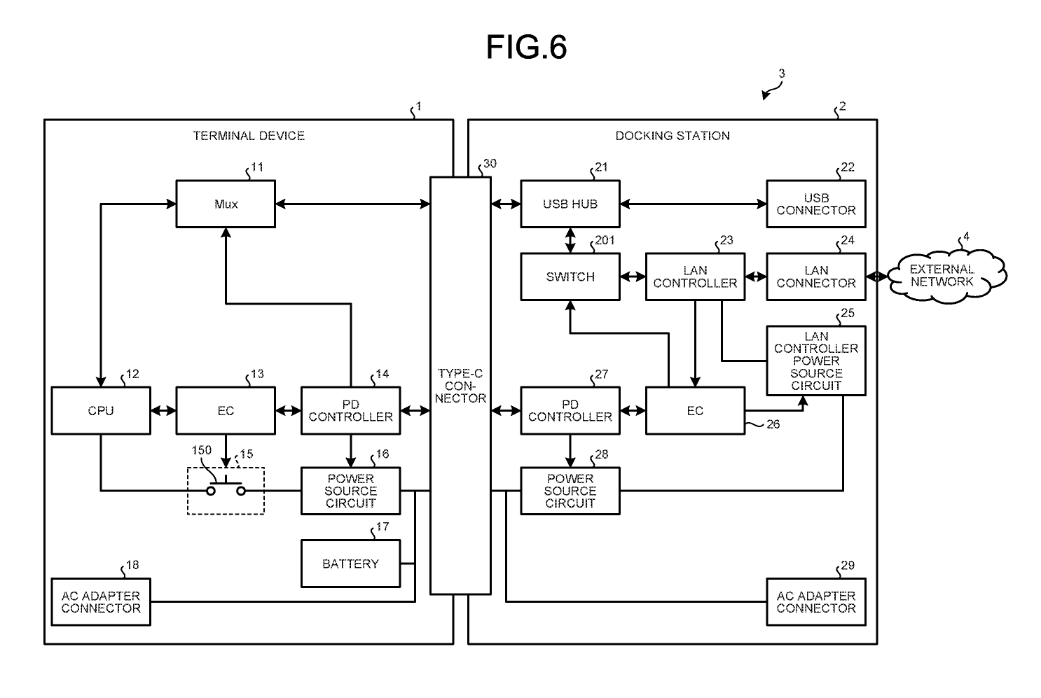

FIG. 6 is a block diagram illustrating the terminal device and the docking station in accordance with a second embodiment. The docking station 2 according to the second embodiment differs from that in the first embodiment in that the docking station 2 according to the second embodiment blocks, when an activation request is transmitted by the CC communication, transmission of a USB signal to the terminal device 1. The docking station 2 according to the second embodiment further includes a switch 201 in addition to each of the function units in the first embodiment. The following mainly describes blocking of transmission of a USB signal. In the following description, explanation on functions of each of the units the same as those in the first embodiment is omitted.

The switch 201 is disposed on a USB bus for connecting the LAN controller 23 with the USB hub 21. The switch 201 is a switch for switching connection or disconnection of a USB bus for connecting the LAN controller 23 with the USB hub 21, and receives input of a USB bus disconnection signal that instructs disconnection of the USB bus from the EC 26 and disconnects a route for connecting the LAN controller 23 with the USB hub 21.

When a GPIO signal for activation is input from the LAN controller 23, the EC 26 checks a stored power source state of the terminal device 1. When a power source state of the terminal device 1 is the shut-down state or the pause state, the EC 26 outputs a USB bus disconnection signal that instructs disconnection of a USB bus to the switch 201.

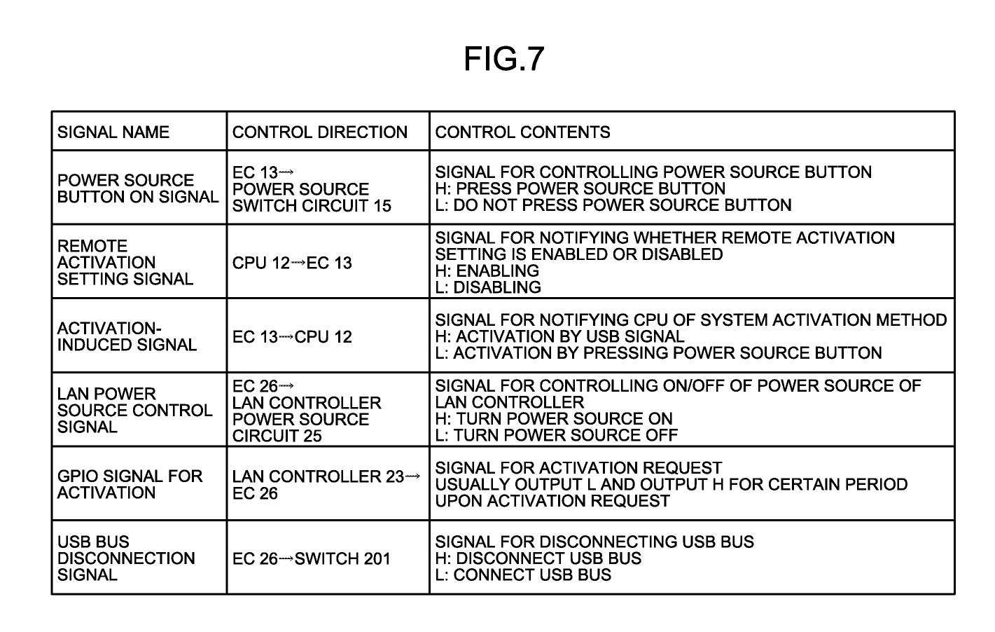

FIG. 7 is a view illustrating an example of various kinds of signals used in the second embodiment. In the second embodiment, a power source button ON signal, a remote activation setting signal, an activation-induced signal, a LAN power source control signal, and a GPIO signal for activation are the same as those in the first embodiment. In addition, a USB bus disconnection signal is used in the second embodiment.

As illustrated in FIG. 7, a USB bus disconnection signal is a signal for disconnecting a USB bus that is transmitted from the EC 26 to the switch 201. In case of a high level, a USB bus disconnection signal instructs disconnection of a USB bus. In case of a low level, a USB bus disconnection signal instructs connection of a USB bus. The EC 26 normally outputs a low-level USB bus disconnection signal to the switch 201. When the EC 26 receives input of a GPIO signal for activation from the LAN controller 23 and a power source state of the terminal device 1 is the shut-down state or the pause state, the EC 26 changes the level of the USB bus disconnection signal to a high level. In this manner, the EC 26 can disconnect a USB bus for connecting the LAN controller 23 with the USB hub 21 so as to block transmission of a USB signal for activation from the LAN controller 23 to the CPU 12.

In addition, the EC 26 sets a value representing enabling of remote activation to a remote activation setting bit in a VDM signal, and instructs the PD controller 27 to transmit the VDM signal.

After the EC 26 completes control of the switch 201, the LAN controller 23 transmits a USB signal for activation to the USB hub 21.

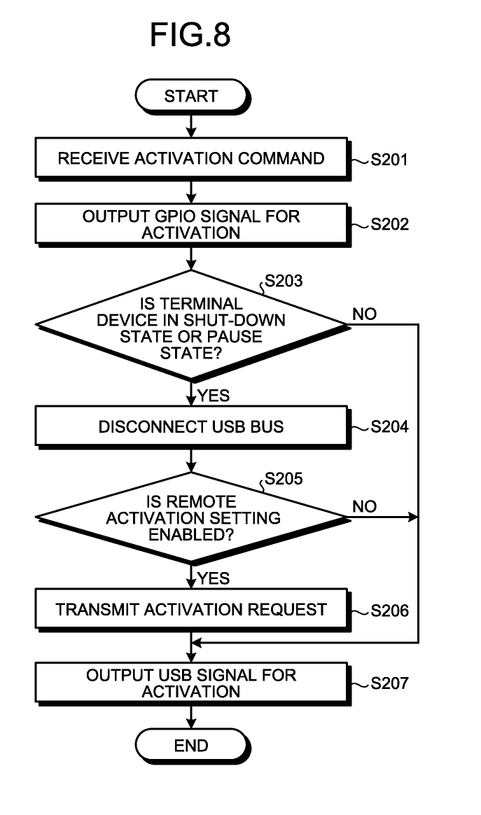

The following describes a flow of processing of the information processing system 3 according to the second embodiment at the time of remote activation with reference to FIG. 8. FIG. 8 is a flowchart of processing of the information processing system according to the second embodiment at the time of remote activation.

The LAN controller 23 receives an activation command from the external network 4 through the LAN connector 24 (step S201).

Subsequently, the LAN controller 23 outputs a GPIO signal for activation to the EC 26 (step S202).

The EC 26 receives input of a GPIO signal for activation. The EC 26 determines which of the shut-down state and the pause state a stored power source state of the terminal device 1 is (step S203). When a power source state of the terminal device 1 is the sleep state, in other words, when a power source state of the terminal device 1 is neither the shut-down state nor the pause state (No at step S203), the process goes to processing at step S207.

By contrast, when a power source state of the terminal device 1 is either the shut-down state or the pause state (Yes at step S203), the EC 26 transmits a USB bus disconnection signal that instructs disconnection of a USB bus to the switch 201 and disconnects the USB bus (step S204).

Subsequently, the EC 26 determines whether or not the remote activation setting is enabled (step S205). When the remote activation setting is disabled (No at step S205), the process goes to processing at step S207.

By contrast, when the remote activation setting is enabled (Yes at step S205), the EC 26 instructs the PD controller 27 to transmit a VDM signal where a value of an activation request bit is set as presence of an activation request. In this manner, the EC 26 transmits an activation request to the terminal device 1 using The CC communication (step S206).

The LAN controller 23 converts an activation command from a LAN signal to a USB signal so as to generate the USB signal for activation. The LAN controller 23 outputs a USB signal for activation to the CPU 12 through the USB hub 21 and the Type-C connector 30 (step S207).

For convenience of explanation, a flow in FIG. 8 describes a case where the LAN controller 23 transmits a USB signal for activation after the EC 26 transmits an activation request, but the LAN controller 23 may transmit a USB signal for activation at any time after the disconnection of a USB bus.

As described above, when a power source state of the terminal device is the sleep state, the information processing system according to the second embodiment activates the terminal device with a USB signal. When a power source state of the terminal device is the shut-down state or the pause state, the information processing system according to the second embodiment turns, after blocking transmission of a USB signal for activation to the terminal device, on a power source button and activates the terminal device using The CC communication. In this manner, the information processing system can protect the USB hub in a state where a power source is turned off so that a voltage is not applied to the USB hub.

What is claimed is:

1. A function enhancement apparatus comprising:
a connector to which an information processing device is connected; and
a first processor that:
acquires a power source state of the information processing device connected to the connector, and
causes, based on the acquired power source state, the information processing device to perform activation by power source control when an activation command to the information processing device is received from an external network.

2. The function enhancement apparatus according to claim 1, wherein when the power source state is a state where power is not supplied to an arithmetic processor of the information processing device, the first processor causes the information processing device to perform the activation to supply power to the arithmetic processor.

3. The function enhancement apparatus according to claim 2, further comprising a second processor that:
receives the activation command,
generates and transmits a first activation request to the arithmetic processor, and
outputs, to the first processor, a second activation request for performing activation by power source control,
wherein when the second activation request is input, the first processor instructs, based on the power source state, the information processing device to perform activation by power source control.

4. The function enhancement apparatus according to claim 3, wherein when the second activation request is input, the first processor blocks transmission of the first activation request from the second processor to the arithmetic processor.

5. A method of controlling an information processing device by a function enhancement apparatus to which the information processing device is connectable, the method comprising:
acquiring a power source state of the information processing device connected to the function enhancement apparatus, and
causing, based on the acquired power source state, the information processing device to perform activation by power source control when an activation command to the information processing device is received from an external network.

6. A non-transitory computer readable medium (CRM) storing computer readable program code that causes a function enhancement apparatus connected to an information processing device to:
acquire a power source state of the information processing device connected to the function enhancement apparatus, and
cause, based on the acquired power source state, the information processing device to perform activation by power source control when an activation command to the information processing device is received from an external network.
